(19) United States
(12) Patent Application Publication
(10) Pub. No.: US 2022/0143923 A1
(43) Pub. Date: May 12, 2022

(54) CARRIAGE POSITION CONTROL

(71) Applicant: Hewlett-Packard Development Company, L.P., Spring, TX (US)

(72) Inventors: Eric Scott Collins, Vancouver, WA (US); Michael Douglas Long, Vancouver, WA (US)

(73) Assignee: Hewlett-Packard Development Company, L.P., Spring, TX (US)

(21) Appl. No.: 17/415,764

(22) PCT Filed: Jul. 25, 2019
(86) PCT No.: PCT/US2019/043473

§ 371 Date: Jun. 18, 2021

(51) Int. Cl. B29C 64/393; B33Y 30/00; B29C 64/236; B33Y 50/02; F16H 19/06

(52) U.S. Cl. CPC B29C 64/393; B33Y 30/00; F16H 2019/0686; B33Y 50/02; F16H 19/06; B29C 64/236

(57) ABSTRACT

In one example, a carriage control process using rotary encoder counts includes: reading an outbound rotational count for a carriage drive when the carriage reaches a first translational reference position in an outbound pass along a path; reading a return rotational count for the carriage drive when the carriage reaches a second translational reference position on a return pass back along the path; advancing a rotational start count for the carriage drive at the beginning of a next outbound pass if the outbound count is less than the first reference count and the return count is less than the second reference count; or retarding a rotational start count for the carriage drive at the beginning of the next outbound pass if the outbound count is more than the first reference count and the return count is more than the second reference count.

### BACKGROUND

3D printers produce objects by building up layers of material. 3D printers are sometimes also referred to as additive manufacturing machines. 3D printers convert a CAD (computer aided design) model or other digital representation of an object into the physical object. The model data may be processed into slices each defining that part of a layer of build material to be formed into the object.

### DRAWINGS

FIG. 1 illustrates a carriage system in which examples of a process to detect and correct for skipped teeth in a toothed carriage drive may be implemented.

FIGS. 2-5 are elevation and partial section views of the carriage system of FIG. 1 showing a carriage at different positions along the path of travel.

FIG. 6 is a flow diagram illustrating an example carriage position control process that might be implemented in the system shown in FIGS. 1-5.

FIGS. 7-12 are diagrams showing example error scenarios to help illustrate the process of FIG. 6.

FIG. 13 is a flow diagram illustrating another example carriage position control process that might be implemented in the system shown in FIGS. 1-5.

The same part numbers designate the same or similar parts throughout the figures. The figures are not necessarily to scale.

### DESCRIPTION

In some 3D printers, particles in each of many successive layers of a powdered build material are bound or fused in the desired pattern to form a solid object layer by layer. A preset quantity of build material powder for each layer may be delivered to a supply deck alongside the build area with a dispenser carried back and forth over the deck. Each such powder “dose” on the supply deck is spread across the build area to the desired thickness with a roller or blade. Correctly positioning the dispenser carriage for the dispensing operations helps ensure that each powder dose is properly located on the deck, and helps keep the dispenser carriage properly positioned at the refill station and out of the way of the spreading and print carriages between dosing.

For dispenser carriages driven by a toothed drive system, the drive geometry, thermal effects, and tolerance stack may cause skipped teeth as the carriage is driven back and forth over the supply deck. A rotary position encoder sensing the rotational position of the motor shaft or other rotary drive component may not detect a skipped tooth directly. Failure to detect and correct for skipped teeth may allow the powder dispenser carriage to get out of position. Accordingly, a new technique has been developed to detect and correct for skipped teeth in a toothed carriage drive.

In one example, a translational reference position along a path traveled by a carriage out and back from a starting position is used to detect skipped teeth. A rotary encoder coupled to the carriage drive is calibrated to the translational reference to establish a rotational reference for the outbound pass and the return pass. During operation, the actual rotational position of the carriage at the translational reference is determined for the outbound and return passes and compared to the corresponding rotational references for both magnitude and direction. If the actual position is different from the reference position on both passes, and the magnitude and direction of the differences match, then it may be determined that a corresponding number of teeth have been skipped. An appropriate correction can then be made in a subsequent outbound pass. The differences for both passes are used as a cross-check against sensor and other errors unrelated to skipped teeth causing a false correction. If the differences in both directions match, then it can be more reliably determined that a tooth has been skipped.

In one example, the threshold against which the magnitude of the positional differences are measured is equivalent to a discrete increment of one or more skipped teeth as a further check against false corrections. Any correction can then be made in discrete increments. Correction may be made, for example, by advancing or retarding the start count on the rotary encoder at the beginning of the next outbound pass depending on the direction of the positional error. The start count is advanced if the positional difference (actual position−reference position) for both passes is negative. The start count is retarded if the positional difference for both passes is positive.

While these examples have been introduced in the context of a powder dispenser carriage in a 3D printer, examples are not limited to 3D printing or dispenser carriages, but may be implemented in other devices and for other applications. These and other examples described below and shown in the figures illustrate but do not limit the scope of the patent, which is defined in the Claims following this Description.

As used in this document: “and/or” means one or more of the connected things; “advance” means to set or move forward and “retard” means to set or move back; a “memory” means any non-transitory tangible medium that can embody, contain, store, or maintain instructions and other information for use by a processor and may include, for example, circuits, integrated circuits, ASICs (application specific integrated circuits), hard drives, random access memory (RAM), and read-only memory (ROM); and a “number of revolutions” includes an integer number of revolutions and/or a fractional number of revolutions, and may be determined, for example, by rotary encoder counts.

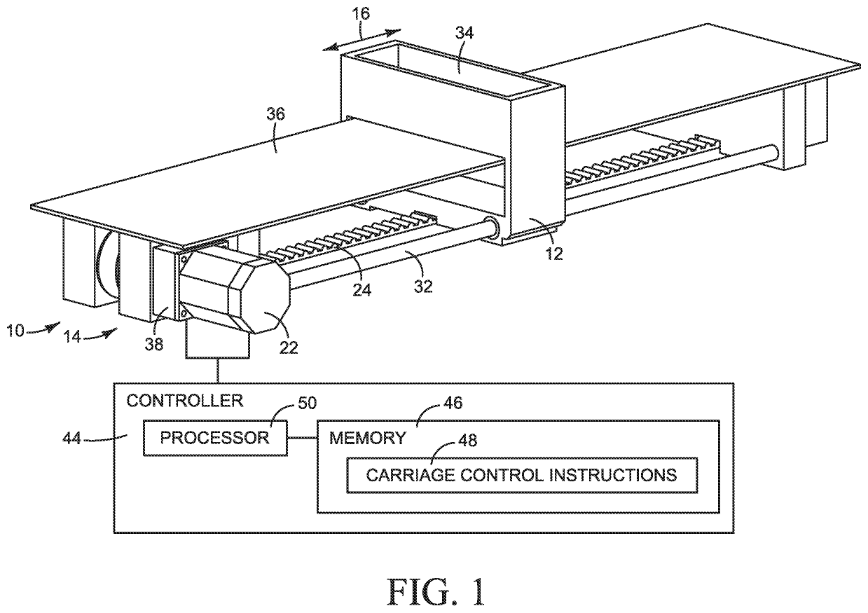

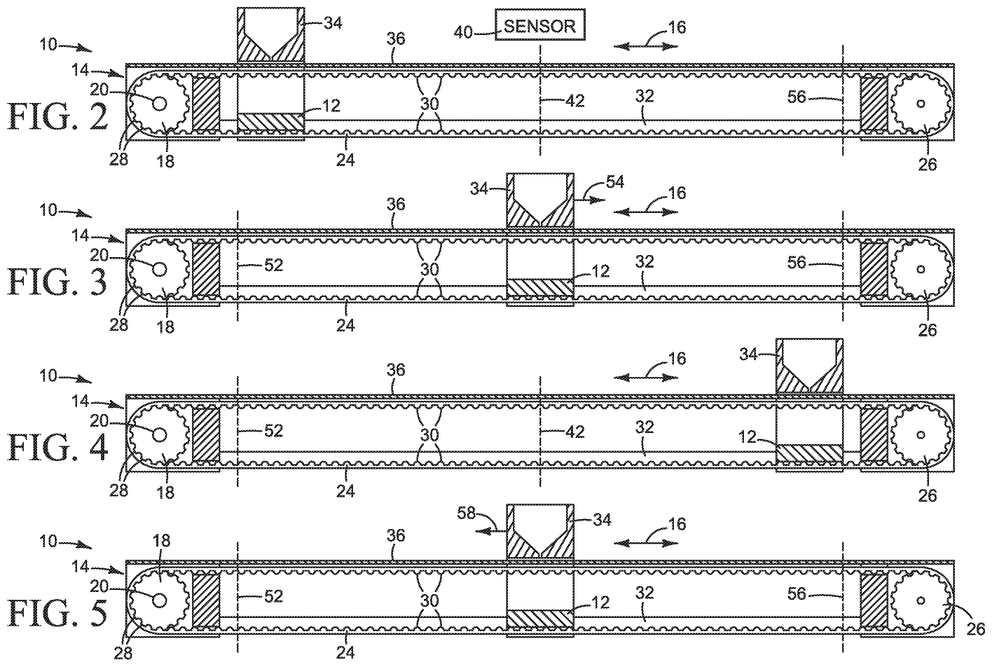

FIG. 1 illustrates a carriage system 10 in which examples of a process to detect and correct for skipped teeth in a toothed carriage drive may be implemented. FIGS. 2-5 are elevation and partial section views of system 10 in FIG. 1 showing the carriage at different positions. Referring to FIGS. 1-5, carriage system 10 includes a carriage 12 and a carriage drive 14 to drive carriage 12 back and forth along a path 16. Drive 14 includes toothed drive gear 18, a shaft 20 connected to gear 18 and a motor 22 to rotate shaft 20. Carriage drive 14 also includes a toothed belt 24 looped around drive gear 18 at one end of path 16 and an idler 26 at the other end of path 16. Although a toothed idler gear 26 is shown, any suitable idler may be used.

Carriage 12 is mounted to belt 24. Teeth 28 on drive gear 18 engage teeth 30 on belt 24 to translate belt 24 with carriage 12 back and forth along path 16 at the urging of motor 22. In this example, carriage 12 is mounted to guide rails 32 and carries a dispenser 34 over a sheet 36, for example to dispense build material powder to a supply deck in a 3D printer. Motor 18 may be implemented, for example, as a servo controlled reversible motor to drive belt 24 with carriage 12 out and back along path 16.

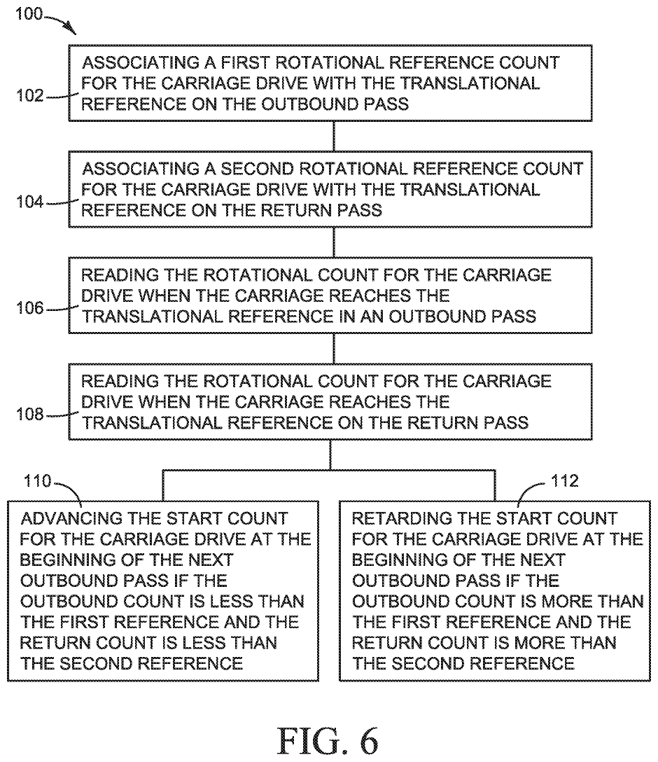

Carriage system 10 also includes a rotary encoder 38 operatively coupled to drive shaft 20 to determine the rotational position of shaft 20, an optical or other suitable sensor 40 to sense carriage 12 at a transitional reference position 42, and a controller 44 operatively connected to motor 22, encoder 38, and sensor 40. Controller 44 represents the processing and memory resources, programming, and the electronic circuitry and components needed to control the operative elements of system 10. In particular, controller 44 includes a memory 46 with carriage control instructions 48 and a processor 50 to read and execute instructions 48, for example to implement the example processes described below with reference to FIGS. 6-13.

Controller 44 may be implemented as part of a global, device controller or as a discrete carriage system controller. Controller 44 may include multiple components among different system components to implement the desired functionality. For one example, the programming and thus the functionality for carriage position control, including memory 46 with instructions 48 and processor 48, may be integrated into an ASIC or other programmable circuitry that performs controls functions for motor 22 and encoder 38.

FIG. 2 shows carriage 12 in a starting position 52 for an outbound pass along path 16. FIG. 3 shows carriage 12 passing translational reference 42 on an outbound pass, as indicated by direction arrow 54. FIG. 4 shows carriage 12 at a starting position 56 for the return pass. FIG. 5 shows carriage 12 passing translational reference 42 on the return pass, as indicated by direction arrow 58. Although starting positions 52, 56 are indicated at the edge of carriage 12, starting positions 52, 56 may be associated with any part of carriage 12 or at any other suitable location. While translational reference 42 is shown midway on path 16, other suitable locations may be used. Also, while the same translational reference 42 is used for both the outbound and return passes in the examples described below, it may be desirable in other examples to use different translational references for the outbound and return passes.

FIG. 6 is a flow diagram illustrating an example carriage position control process 100 that might be implemented by controller 44 executing instructions 48 in system 10 shown in FIGS. 1-5. Part numbers in the description of FIG. 6 refer to FIGS. 1-5. Rotational positions in FIG. 6 are determined by counts of rotary encoder 38 which, in this example, is coupled to drive shaft 20. The rotational position of another rotary component in carriage drive 14 could be used for carriage position control process 100.

Referring to FIG. 6, process 100 includes associating a first rotational reference count for drive shaft 20 with translational reference 42 on the outbound pass (block 102) and associating a second rotational reference count for drive shaft 20 with translational reference 42 on the return pass (block 104). The associations in blocks 102 and 104 in FIG. 6 may be made by turning drive shaft 20 under conditions in which no teeth can be skipped and recording the encoder count at translational reference 42 on the outbound and return passes. In a 3D printer, for example, associating the two rotational reference counts to the translational reference for a powder dispenser carriage may be performed as part of a calibration procedure during pre-build layering.

Process 100 also includes reading the rotational count for drive shaft 20 when carriage 12 reaches translational reference 42 in an outbound pass along path 16 (block 106) and reading the rotational count for drive shaft 20 when carriage 12 reaches translational reference 42 on the return pass back along path 16 (block 108). If the outbound count is less than the first reference and the return count is less than the second reference, then a correction is made by advancing the start count for drive shaft 20 at the beginning of a next outbound pass (block 110). If the outbound count is more than the first reference and the return count is more than the second reference, then a correction is made by retarding the start count for drive shaft 20 at the beginning of the next outbound pass (block 112).

Using the count-to-reference difference on both passes as well as the direction of any difference helps protect against sensor and other “noise” unrelated to skipped teeth causing a false correction that might otherwise be made in a subsequent outbound pass. Direction is this context refers to whether carriage 12 will overshoot or undershoot target starting position 52 for the next outbound pass. Direction is indicated by the sign ± of the difference between the actual count and the corresponding reference count. A positive difference in both passes indicates that carriage 12 will overshoot target starting position 52 at the end of the return pass. A negative difference in both passes indicates that carriage 12 will undershoot target position 52 at the end of the return pass. The direction may be unclear if one difference is positive and the other negative. Thus, the rotational start count is advanced at block 110 in FIG. 6 if the outbound count is less than the first reference count and the return count is less than the second reference count, and the start count is retarded at block 112 if the outbound count is more than the first reference count and the return count is more than the second reference count.

In one example, the carriage drive is advanced or retarded a number corresponding to the smaller of the magnitude of the two differences—(1) the difference between the outbound count and the first reference and (2) the difference between the return count and the second reference. Using the smaller of the two differences also helps protect against a false correction. As a further check against false corrections, the start count may be changed (advanced or retarded) only if a magnitude of the smaller of the two differences equals or exceeds a threshold corresponding to an integer number of discrete units associated with carriage drive 14, for example the number of counts corresponding to a skipped tooth 28 or a multiple of a skipped tooth 28.

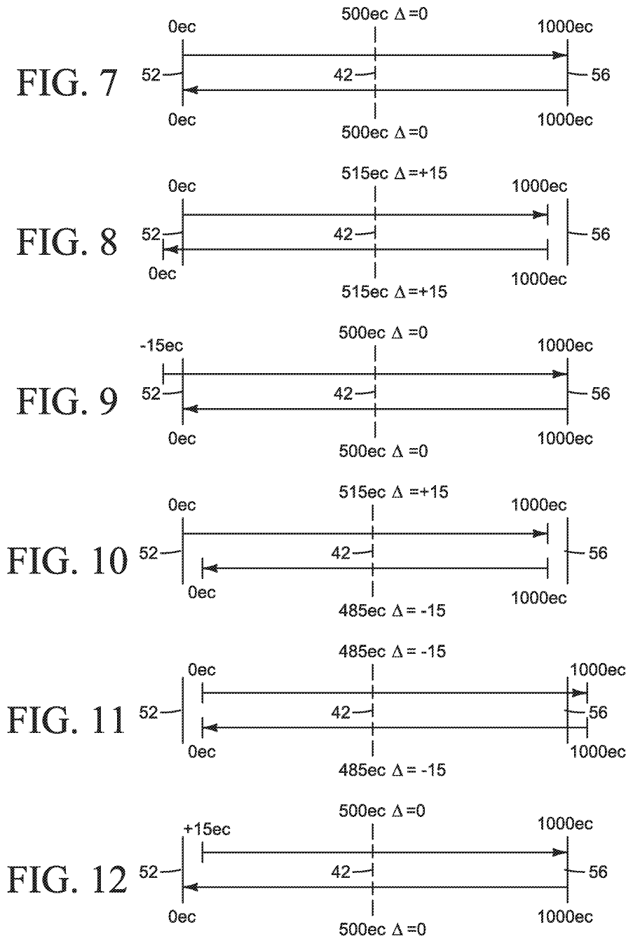

Example error scenarios are shown in FIGS. 7-12 to help illustrate process 100 in FIG. 6. In the examples shown FIGS. 7-12, the distance between the target outbound start position 52 and the target return start position 56 is equivalent 1000 ec (encoder counts). The rotational reference count to translational reference 42 is 500 ec for both the outbound pass and the return pass, and rotary encoder 38 counts up on the outbound pass and counts down on the return pass. Each skipped tooth is equivalent to 15 ec (1000 ec÷66 teeth along path 16 in FIGS. 1-5=15 ec/tooth).

In the cycle shown in FIG. 7, no teeth are skipped in the outbound pass and no teeth are skipped in the return pass. On the outbound pass, carriage 12 travels a distance 500 ec to reach translational reference 42, encoder 38 counts up from 0 ec to 500 ec (no skipped teeth) at translation reference 42, and the difference between the outbound count and the rotational reference is 0 ec (500 ec−500 ec=0 ec). On the return pass, carriage 12 travels a distance 500 ec to reach translational reference 42, encoder 38 counts down from 1000 ec to 500 ec (no skipped teeth) at translational reference 42, and the difference between the return count and the rotational reference is 0 ec (500 ec−500 ec=0 ec). Thus, the difference between the outbound count and the rotational reference is 0 ec and the difference between the return count and the rotational reference is 0 ec. No correction is indicated.

In the cycle shown in FIG. 8, one tooth is skipped on the outbound pass before carriage 12 reaches translational reference 42 and no teeth are skipped on the return pass. On the outbound pass, carriage 12 travels a distance 500 ec to reach translational reference 42 on the outbound pass, encoder 38 counts up from 0 ec to 515 ec (1 skipped tooth) at translation reference 42, and the difference between the outbound count and the rotational reference is +15 ec (515 ec−500 ec=+15 ec). Carriage 12 undershoots target return start 56 by one tooth (15 ec) on the outbound pass. On the return pass, carriage 12 travels a distance 485 ec to reach translational reference 42, encoder 38 counts down from 1000 ec to 515 ec (no skipped teeth) at translational reference 42, and the difference between the return count and the rotational reference is +15 ec (515 ec−500 ec=+15 ec). Carriage overshoots target outbound start 52 by one tooth (15 ec) on the return pass. Thus, the difference between the outbound count and the rotational reference is +15 and the difference between the return count and the rotational reference is +15. A correction retarding the encoder count the equivalent of one tooth (−15 ec) is indicated.

Rotary encoder 38 is reset to begin the next outbound pass at −15 ec as shown in FIG. 9. Retarding the encoder count a magnitude of 15 ec increases the number of revolutions drive shaft 20 is turned on the next outbound pass by one tooth 28 (from 1000 ec to 1015 ec) so that carriage 12 travels one tooth farther to make up for the one tooth skipped in the previous cycle.

In the cycle shown in FIG. 9, no teeth are skipped on the outbound pass and no teeth are skipped on the return pass. On the outbound pass, carriage 12 travels a distance 515 ec to reach translational reference 42, encoder 38 counts up from −15 ec to 500 ec (no skipped teeth) at translation reference 42, and the difference between the outbound count and the rotational reference is 0 ec (500 ec−500 ec=0 ec). On the return pass, carriage 12 travels a distance 500 ec to reach translational reference 42, encoder 38 counts down from 1000 ec to 500 ec (no skipped teeth) at translational reference 42, and the difference between the return count and the rotational reference is 0 ec (500 ec−500 ec=0 ec). Thus, the difference between the outbound count and the rotational reference at translational reference 42 is 0 and the difference between the return count and the rotational reference is 0. No correction is indicated.

In the cycle shown in FIG. 10, one tooth 28 is skipped on the outbound pass before carriage 12 reaches translational reference 42 and two teeth 28 are skipped on the return pass before carriage 12 reaches translational reference 42. On the outbound pass, carriage 12 travels a distance 500 ec to reach translational reference 42 on the outbound pass, encoder 38 counts up from 0 ec to 515 ec (1 skipped tooth) at translation reference 42, and the difference between the outbound count and the rotational reference is +15 (515 ec−500 ec=+15 ec). On the return pass, carriage 12 travels a distance 485 ec to reach translational reference 42, encoder 38 counts down from 1000 ec to 485 ec (2 skipped teeth) at translational reference 42, and the difference between the return count and the rotational reference is −15 ec (485 ec−500 ec=−15 ec). Thus, the difference between the outbound count and the rotational reference is +15 and the difference between the return count and the rotational reference is −15 ec. Carriage 12 undershoots target outbound start 52 by one tooth (15 ec) at the end of the return pass. However, while the magnitude of both differences equals or exceeds the threshold of 15 ec, the difference on the outbound pass is positive (+15 ec) and the difference on the return pass is negative (−15). Therefore, controller 44 may not reliably determine from the encoder counts that carriage 12 has undershot or overshot target outbound star position 52. Therefore, no correction is indicated.

In the cycle shown in FIG. 11, no teeth are skipped on the outbound pass and no teeth are skipped on the return pass. On the outbound pass, carriage 12 travels a distance 485 ec to reach translational reference 42, encoder 38 counts up from 0 ec to 485 ec (no skipped teeth) at translation reference 42, and the difference between the outbound count and the rotational reference is −15 ec (485 ec−500 ec=−15 ec). Carriage 12 overshoots target return start 56 by one tooth (15 ec) at the end of the outbound pass. On the return pass, carriage 12 travels a distance 515 ec to reach translational reference 42, encoder 38 counts down from 1000 ec to 485 ec (no skipped teeth) at translational reference 42, and the difference between the return count and the rotational reference is −15 ec (485 ec−500 ec=−15 ec). Carriage 12 undershoots target outbound start 52 by one tooth (15 ec) at the end of the return pass. The difference between the outbound count and the rotational reference is −15 ec and the difference between the return count and the rotational reference is −15 ec. A correction advancing the encoder count the equivalent of one tooth (+15 ec) is indicated.

Rotary encoder 38 is reset to begin the next outbound pass at +15 ec as shown in FIG. 12. Advancing the encoder count a magnitude of 15 ec decreases the number of revolutions drive shaft 20 is turned on the next outbound pass by one tooth 28 (from 1000 ec to 985 ec) so that carriage 12 travels one tooth shorter to make up for the teeth skipped in the FIG. 10 cycle.

In the cycle shown in FIG. 12, no teeth are skipped on the outbound pass and no teeth are skipped on the return pass. On the outbound pass, carriage 12 travels a distance 485 ec to reach translational reference 42, encoder 38 counts up from +15 ec to 500 ec (no skipped teeth) at translation reference 42, and the difference between the outbound count and the rotational reference is 0 ec (500 ec−500 ec=0 ec). On the return pass, carriage 12 travels a distance 500 ec to reach translational reference 42, encoder 38 counts down from 1000 ec to 500 ec (no skipped teeth) at translational reference 42, and the difference between the return count and the rotational reference is 0 ec (500 ec−500 ec=0 ec). Thus, the difference between the outbound count and the rotational reference at translational reference 42 is 0 ec and the difference between the return count and the rotational reference is 0 ec. No correction is indicated.

Depending on the resolution of encoder 38 and the servo control for motor 22, it may not always be possible to stop carriage 12 precisely at 0 ec at the end of the return pass and 1000 ec at the end of the outbound pass. (Again, these start and end encoder counts are examples only.) In some examples, therefore, rotary encoder 38 is queried to determine the encoder count at each stop. If the count is different from the target count, then an appropriate correction may be made to reset encoder 38 to the target count, including any correction made for skipped teeth as described above. Similarly, if target start 52 is a hard stop, then encoder 38 may be queried to determine the count for a hard stop at target start 52 before making any correction for skipped teeth. Using an integer number of discrete units associated with the carriage drive (gear teeth in this example) and comparing the encoder count in both directions, and then making any correction in discrete units from a known/queried stop, all help to separate skipped tooth error from the “noise” in a carriage control system 10.

Also, rotary encoder 38 may be polled at an interrupt frequency (1) sufficient to obtain an encoder count within the sensing window of sensor 40 and (2) so that the distance traveled by carriage 12 between interrupts is less than the tooth pitch on drive gear 18. Using increments of tooth pitch for error determination, as described above, in combination with this manner of encoder polling neutralizes any adverse effect of a discrepancy between the carriage position at the sensor trigger and the carriage position at encoder polling might otherwise have on the correction for skipped teeth.

Carriage system 10 with drive 14 in FIGS. 1-5 is just one example for implementing carriage position control. Other carriage systems and drive configurations may be used. Examples are not limited to correcting for skipped teeth or toothed drives in general. Carriage position errors caused by other and/or different rotary drive components may be corrected with the example processes described herein using discrete units associated with those components.

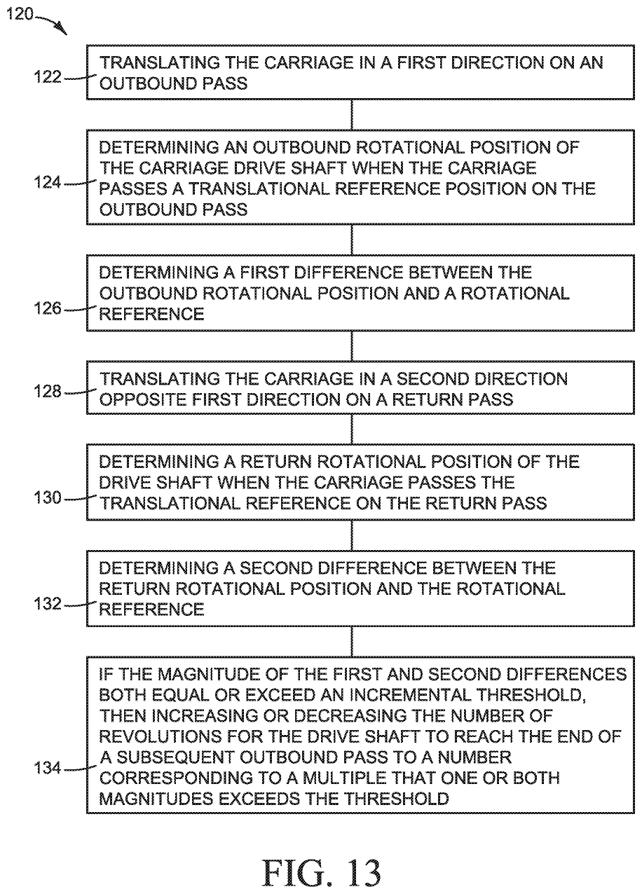

FIG. 13 is a flow diagram illustrating another example carriage position control process 120 that might be implemented by controller 44 executing instructions 48 in system 10 shown in FIGS. 1-5. Part numbers in the description of FIG. 13 refer to FIGS. 1-5. Revolutionary positions in FIG. 13 are determined by counts of rotary encoder 38 which, in this example, is coupled to drive shaft 20. The rotational position of another rotary component in carriage drive 14 could be used for carriage position control process 120.

Referring to FIG. 13, process 120 includes translating carriage 12 in a first direction 54 on an outbound pass (block 122), determining an outbound rotational position of carriage drive shaft 20 when carriage 12 passes translational reference 42 on the outbound pass (block 124), and determining a first difference between the outbound rotational position and a rotational reference (block 126). Process 120 also includes translating carriage 12 in a second direction 58 opposite the first direction 54 on a return pass (block 128), determining a return rotational position of drive shaft 20 when carriage 12 passes translational reference 42 on the return pass (block 130), and determining a second difference between the return rotational position and the rotational reference (block 132). If the magnitude of the first and second differences both equal or exceed an incremental threshold, then increasing or decreasing the number of revolutions for drive shaft 20 to reach the end of a subsequent outbound pass an integer number of discrete units associated with the carriage drive (block 134). In one example for process 120, the discrete unit represents one tooth of a toothed gear on the carriage drive and the threshold corresponds to an integer number of teeth, as described above with reference to FIGS. 7-12.

The examples shown in the figures and described above illustrate but do not limit the patent, which is defined in the following Claims.

“A” and “an” used in the claims means one or more.

1. A carriage control process using rotary encoder counts, comprising:
reading an outbound rotational count for a carriage drive when the carriage reaches a first translational reference position in an outbound pass along a path;
reading a return rotational count for the carriage drive when the carriage reaches a second translational reference position on a return pass back along the path;
advancing a rotational start count for the carriage drive at the beginning of a next outbound pass if the outbound count is less than the first reference count and the return count is less than the second reference count; or
retarding a rotational start count for the carriage drive at the beginning of the next outbound pass if the outbound count is more than the first reference count and the return count is more than the second reference count.

2. The process of claim 1, comprising advancing or retarding the rotational start count for the carriage drive at the beginning of the next outbound pass a number corresponding to a smaller of:
a magnitude of a difference between the outbound rotational count and the first rotational reference count; and
a magnitude of a difference between the return rotational count and the second rotational reference count.

3. The process of claim 2, comprising advancing or retarding the rotational start count only if the magnitude of the smaller of the two differences equals or exceeds a threshold.

4. The process of claim 3, wherein:
the threshold represents an integer number of discrete units associated with the carriage drive; and
the advancing or retarding comprises advancing or retarding the rotational start count a number corresponding to the integer number of discrete units the magnitude of the smaller of the two differences equals or exceeds the threshold.

5. The process of claim 4, wherein the discrete unit is equivalent to one skipped tooth on a toothed carriage drive.

6. The process of claim 1, wherein the first translational reference position is the same as the second translational reference position.

7. A memory to implement a carriage control process, the memory including instructions thereon to:
translate the carriage in a first direction on an outbound pass;
determine an outbound rotational position of a carriage drive when the carriage passes a translational reference position on the outbound pass;
determine a first difference between the outbound rotational position and a rotational reference;
translate the carriage in a second direction opposite the first direction on a return pass;
determine a return rotational position of the carriage drive when the carriage passes the translational reference position on the return pass;
determine a second difference between the return rotational position and the rotational reference; and
if a magnitude of the first and second differences both equal or exceed a threshold, then increase or decrease a number of revolutions for the carriage drive to reach the end of a subsequent outbound pass an integer number of discrete units associated with the carriage drive.

8. The memory of claims 7, wherein the threshold corresponds to an integer number of the discrete units.

9. The memory of claim 8, wherein the instructions to increase or decrease the number of revolutions includes instructions to:
increase the number of revolutions if the first difference is negative and the second difference is negative; and
decrease the number of revolutions if the first difference is positive and the second different is positive.

10. The memory of claim 9, wherein the discrete unit represents one tooth of a toothed gear on the carriage drive.

11. A carriage control system, comprising:
a toothed drive gear;
a rotatable shaft operatively connected to the drive gear;
a reversible motor to rotate the shaft;
a toothed belt looped around the drive gear at one end of a linear path traveled by the belt and looped around an idler at the other end of the path, teeth on the drive gear engaging teeth on the belt;
a carriage translatable with the belt back and forth along the path at the urging of the motor;
a rotary encoder operatively connected to the shaft; and
a sensor located at a translational reference position along the path to sense the carriage passing the translational reference position; and
a controller operatively connected to the motor, the rotary encoder and the sensor, the controller programmed to:
in an outbound pass, cause the motor to rotate the shaft in one direction to translate the carriage along the path away from a starting position;
in a return pass, cause the motor to rotate the shaft in a reverse direction to translate the carriage along the path back toward the starting position;
read an outbound count on the rotary encoder when the sensor senses the carriage passing the translational reference position on the outbound pass;
read a return count on the rotary encoder when the sensor senses the carriage passing the translational reference position on the return pass;
advance a rotational start count for the shaft at the beginning of a next outbound pass if the outbound count is less than the first reference count and the return count is less than the second reference count; or
retard a rotational start count for the shaft at the beginning of the next outbound pass if the outbound count is more than the first reference count and the return count is more than the second reference count.

12. The system of claim 11, wherein the controller is programmed to repeat the causing, reading, and advancing or retarding for successive outbound and return passes.

13. The system of claim 11, wherein the controller is programmed to advance or retard the start count a number corresponding to a smaller of:
a magnitude of a difference between the outbound count and the first reference count; and
a magnitude of a difference between the return count and the second reference count

14. The system of claim 13, wherein the controller is programmed to advance or retard the start count only if a magnitude of the smaller of the two differences equals or exceeds a threshold corresponding to a tooth on the drive gear.
